(19) United States
(12) Patent Application Publication
(10) Pub. No.: US 2007/0290170 A1
(43) Pub. Date: Dec. 20, 2007

(54) METHOD OF INCREASING FLUORESCENCE INTENSITY OF OXIDE GLASS

(76) Inventor: Tuan-Jye DING, Miao Li City (TW)

Correspondence Address: SINORICA, LLC, 528 FALLSGROVE DRIVE, ROCKVILLE, MD, 20850, US

(21) Appl. No.: 11/740,938

(22) Filed: Apr. 27, 2007

(30) Foreign Application Priority Data
Jun. 16, 2006 (TW) 95121532

(51) Int. Cl. C09K 11/78; C09K 11/59; C09K 11/70

(52) U.S. Cl. 252/301.4 P; 252/301.4 R

(57) ABSTRACT

The present invention provides a method performing a glass split phase technique to make an oxide glass with a strong structure phase and a weak structure phase. The strong structure phase has a three-dimensional continuous web-like distribution, and the weak structure phase has a continuous web-like distribution or an independent drop-like distribution. The weak structure phase receives rare earth elements therein more than the strong structure phase. Therefore, the rare earth elements are concentrated in the weak structure phase to increase the fluorescence intensity of the oxide glass by an increase of a concentration and a fluorescence efficiency of the rare earth elements.

### BACKGROUND OF THE INVENTION

1. Field of the Invention

The present invention relates generally to a method of making a rear earth element doped silicate glass and the constituents thereof, and more particularly to a method of increase the fluorescence intensity of oxide glass.

2. Description of the Related Art

Typically, silicate glass (including crystal glass) is constructed of silicon oxide with tetrahedral atomic structure. This kind of atomic structure has the doped rear earth element, such as europium ion, neodymium ion and erbium ion, under 3 mol % or else the glass will lose its penetrability. Compare with the silicate glass, phosphate glass has a loose structure, which means, phosphate glass may be doped with more rare earth element than silicate glass. Because that phosphate glass may be doped with more rare earth element (over 10 mol %) and its melting temperature (about 600° C. to 1,300° C.) is much lower than that of silicate glass (about 1,300° C. to 1,600° C.), it shows the glass atomic structure of the phosphate glass is loose than that of silicate glass. Another kind of glass is borate, which atomic structure is looser than silicate glass too, so that borate glass has lower melting temperature (about 400° C. to 1,200° C.) and may be doped with more rare earth element than silicate glass because of its loose structure.

Although phosphate glass and borate glass may be doped with more rare earth element, but silicate glass has better chemical property and strong strength so that silicate glass is more popular to be incorporated in commercial products than phosphate glass and borate glass.

Because that silicate glass is the common material to be doped with rare earth element, particularly for laser glass, optical fiber laser, fluorescent glass, and other glasses with light emitting property, so that how to increase the doped rare earth element in the silicate glass is an important issue in manufacture of fluorescent glass.

### SUMMARY OF THE INVENTION

The primary objective of the present invention is to provide a method of increase a fluorescence intensity of oxide glass, which may raise the concentration of rare earth element in the glass and the fluorescence performance to increase the fluorescence intensity.

According to the objective of the present invention, a method includes performing a glass split phase technique to make an oxide glass with a strong structure phase and a weak structure phase. The strong structure phase has a three-dimensional continuous web-like distribution, and the weak structure phase has a continuous web-like distribution or an independent drop-like distribution. The weak structure phase receives rare earth elements therein more than the strong structure phase. Therefore, the rare earth elements are concentrated in the weak structure phase to increase the fluorescence intensity of the oxide glass by an increase of a concentration and a fluorescence efficiency of the rare earth elements.

### BRIEF DESCRIPTION OF THE DRAWINGS

FIG. 1 is a diagram showing the absorption spectrums of the present invention doped with various concentrations of europium oxide;

FIG. 2 is another diagram showing the absorption spectrum of the present invention doped with various concentrations of oxide europium;

FIG. 3 is a micro picture of europium-doped sodium borosilicate glass in heat treatment under 700° C. for 12 hours;

FIG. 4 is a micro picture of europium-doped sodium borosilicate glass in heat treatment under 750° C. for 24 hours;

FIG. 5 is a micro picture of europium-doped sodium borosilicate glass in heat treatment under 700° C. for 60 hours;

FIG. 6 is a diagram of relationship of time of heat treatment and the fluorescence spectrum of europium-doped sodium borosilicate glass;

FIG. 7 is a diagram of relationship of time of heat treatment and the fluorescence spectrum of europium-doped sodium borosilicate glass;

FIG. 8 is a sketch diagram of the europium ion distributions before and after split phase of glass;

FIG. 9 is a micro structure of glass after spinodal decomposition split phase;

FIG. 10 is a micro structure of glass after nucleation and growth split phase;

FIG. 11 is a diagram of split phase free energy and chemical constituents of glass in thermodynamics, showing the relationship of spinodal decomposition and nucleation and growth.

### DETAILED DESCRIPTION OF THE INVENTION

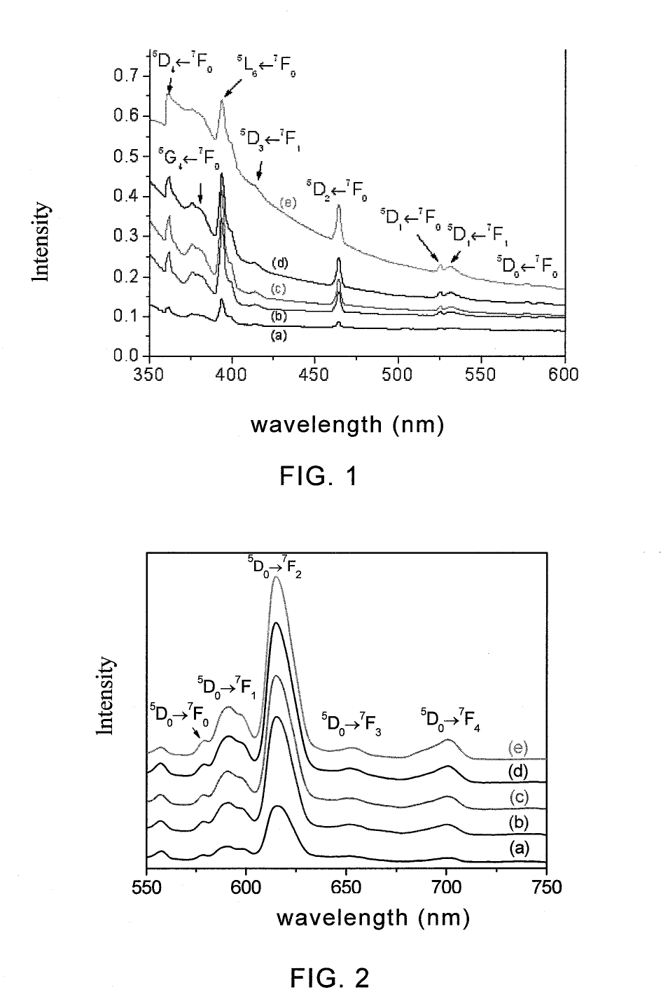

As shown in FIG. 1, a method of a preferred embodiment of the present invention to increase a fluorescence intensity of oxide glass is provided with silicon oxide (SiO₂), boric acid (H₃BO₃), sodium carbonate (Na₂CO₃), europium oxide (Eu₂O₃), ammonium dihydrogen phosphate (NH₃H₂PO₃), and aluminum hydroxide (Al(OH)₃) as raw materials. Constituents of the glass are shown in Table 1. These constituents are well mixed and put in a platinum crucible to be heated up to 1,400° C.˜1,500° C. with a rate of 10° C./min and keep it at the highest temperature for 30 minutes. After heating, the melting material is poured into a pre-heated iron mold and fast chilling, and then it performs annealing treatment to have a glass. Glass split phase technique includes cutting aforesaid glass by diamond wire saw into a size of 10 mm×5 mm×5 mm, and then put it into a resistor-type thermocouple stove, which had been pre-heated to 570° C.˜750° C., for heat treatment. After that, the glass is cooled to room temperature and analyzed for its properties. The equipments for analysis and measurement of the glass include Inductively Coupled Plasma Atomic Emission Spectrometry (ICP-AES), Scanning electronic microscopy (SEM), UV-Visible-NIR spectroscopy, and Perkin Elmer Luminescence spectrometer.

The glass is doped with 59SiO₂₉-33B₂O₃-8Na₂O-xEu₂O₃, x=0.5, 1.0, 1.5, 2.0, 2.5, and 40SiO₂-35P₂O₅-15Na₂O-6Al₂O₃-1Eu₂O₃ and heated under 1,500° C. to be molded at room temperature. The glass is analyzed and measured after annealing. Some glasses are treated by different heat treatments to form glass split phase, and then they are analyzed and measured too.

FIG. 1 shows the absorption spectrums of Eu³ ion in sodium borosilicate glasses doped with europium oxides of different concentrations, in which Eu³ ions are excited from ⁷F_{0, 1} energy level to different 4f⁶ and absorption peaks are appeared at 577 nm, 531 nm, 525 nm, 464 nm, 413 nm, 393 nm, 376 nm, and 361 nm in sequence. They represent ⁵D₀←⁷F₀, ⁵D₁←⁷F₀, ⁵D₂←⁷F₀, ⁵D₃←⁷F₀, ⁵L₆←⁷F₀, ⁵G₃←⁷F₀, and ⁵D₄←⁷F₀, the greater of Eu₂O₃, the greater of the intensity of the absorption peaks. The absorption peaks are not distinct at ⁵D₀←⁷F₀, ⁵D₁←⁷F₀, and ⁵D₃←⁷F₀. The peak at ⁵D₀←⁷F₀ is almost zero. That is electrons are not allowable to jump from J=0 to J′=0. For ⁵D₁←⁷F₀, and ⁵D₃←⁷F₀, electrons are forbidden to jump from J=0 to J=odd numbers. As a result, we choose 464 nm to be a wavelength of an exciting light source of fluorescence spectrum.

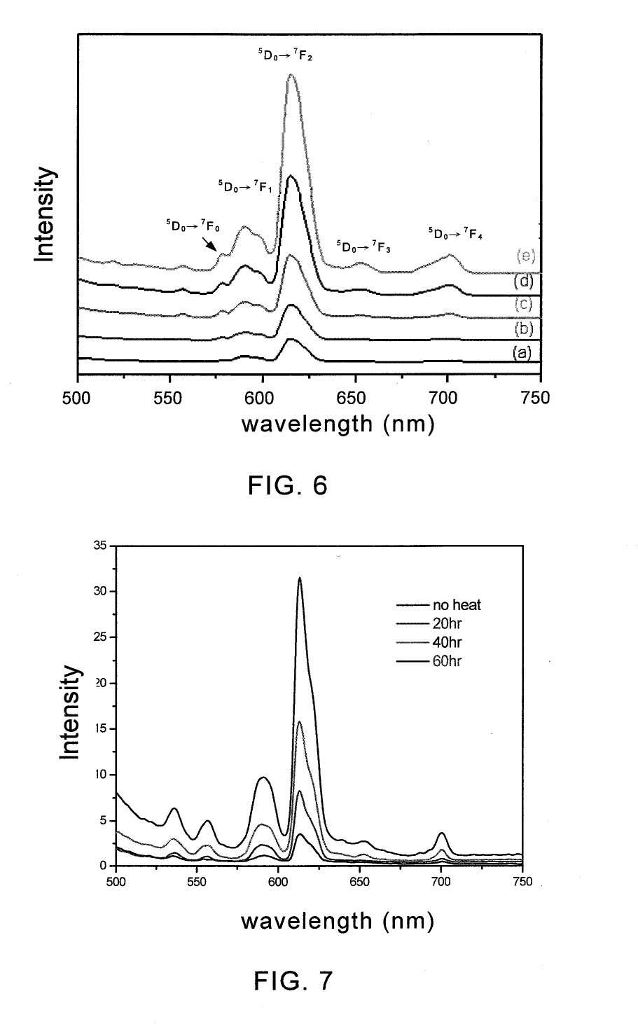

FIG. 2 shows a fluorescence spectrum, in which the wavelength of light is 464 nm foe measurement of sodium borosilicate glasses doped with different concentrations of europium oxide. The results show the radiation spectrum of Eu³⁺ ion from ⁵D₀ energy level back to ⁷F_{0, 1, 2, 3, 4}, and have radiation peaks at 578 nm, 591 nm, 615 nm, 652 nm and 700 nm in sequence. The radiation peaks represent the energy transfer between the energy levels of ⁵D₀→⁷F₀, ⁵D₀→⁷F₁, ⁵D₀→⁷F₂, ⁵D₀→⁷F₃, and ⁵D₀→⁷F₄. FIG. 5 and FIG. 6 show the glasses without split phase which the results show the intensities of light absorption and fluorescence radiation are greater when there are higher concentrations of europium ions in the glasses. But there only is a little increase. The increase of the intensity of fluorescence is less than 3 times when the concentration of europium ions is increased from 0.5 mol to 2.5 mol, and it will decrease the transparency of glass when the concentration of europium ions is greater than 2.5 mol. Sometime, there are crystallizations in the glass that make the glass opaque.

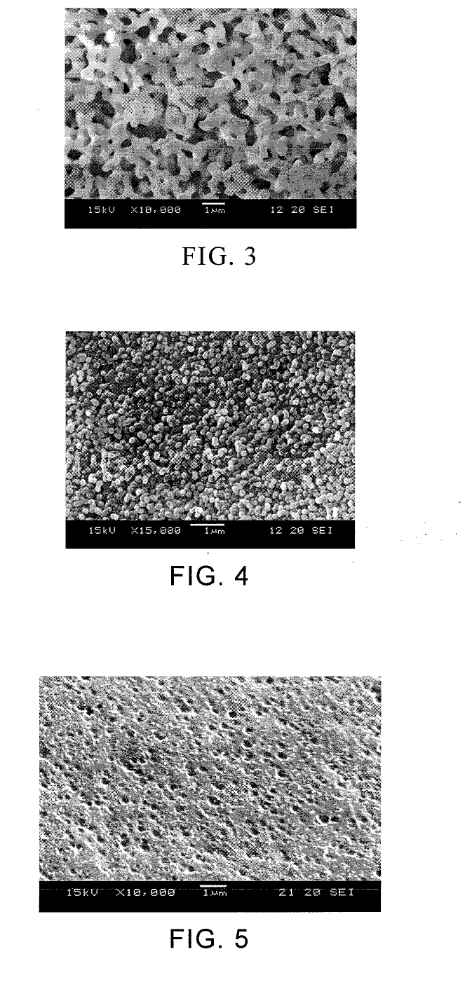

The glass, after specific heat treatment for split phase and surface treatment of acid, could be seen clearly of its split under a scanning electronic microscopy (SEM) with magnification of 10,000 times to 15,000 times. FIG. 3 to FIG. 5 are pictures of the microstructure of split phases of europium-doped sodium borosilicate glass (59SiO₂-33B₂O₃-8Na₂O-xEu₂O₃) and europium-doped sodium phosphorus silicate glass (40SiO₂-35P₂O₅-15Na₂O-6Al₂O₃-1Eu₂O₃). The europium-doped sodium borosilicate glass (59SiO₂-33B₂O₃-8Na₂O-xEu₂O₃) sample, which is treated under 700° C. for 12 hours, still has a spinodal decomposition microstructure. As shown in FIG. 3, the split phase is about 400 nm at a region with silicate and is wider at a region washed away by acid to be seen under the glass with a plurality of through bores. The glass sample with the same constituents, which is treated under 750° C. for 24 hours, has a water drop like of nucleation and growth microstructure, as shown in FIG. 4.

Acid washing the split phase glass of FIG. 3 by 0.5N hydrochloric acid (HCl) to melt the boron-rich glass into a dilute hydrochloric acid solution, and then analyze the washing solution by coupled plasma-atomic emission spectrometer. The results show that the concentration of europium oxide in the boron-rich glass is 4.36 mole %, which is higher than the concentration of europium oxide (2 mole %) in the original glass. This tells that there are about 2.36 mole % europium oxide coming out of the phase of the silicon glass and entering the phase of boron-rich glass.

FIG. 5 shows a picture of sodium phosphorus silicate glass doped with europium (40SiO₂-35P₂O₅-15Na₂O-6Al₂O₃-1Eu₂O₃), which is treated under 750° C. for 60 hours. It has a water drop like split phase shape of nucleation and growth. The split phase speed of the phosphorus silicate glass is slower than that of the borosilicate glass. The split phase size is about 100 nm after sixty hours' heat treatment that is slow than the split phase speed of borosilicate glass.

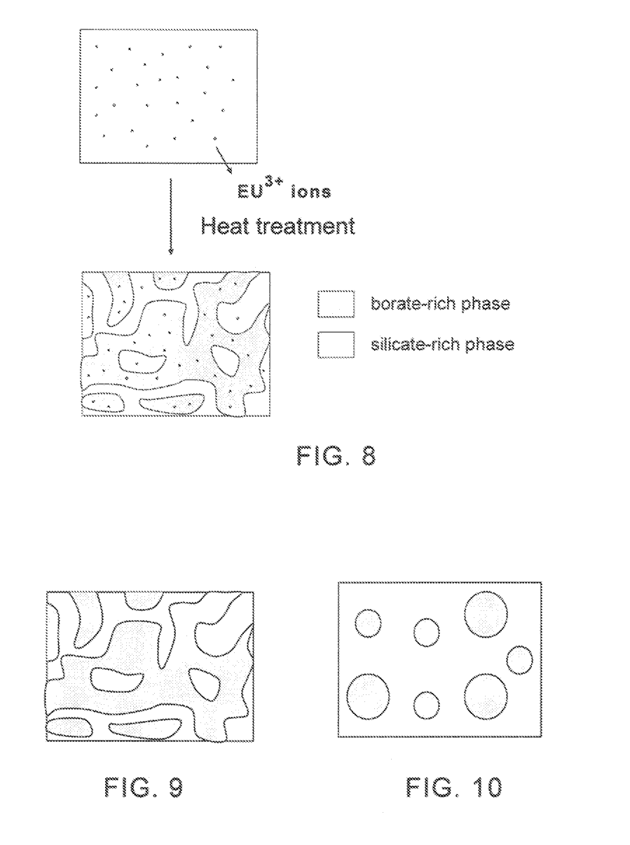

FIG. 6 and FIG. 7 show rare earth ions have more time for diffusion into a phase with a loose structure, such as boron-rich phase and phosphorus glass, when time of the heat treatment is prolonged. For the same glass, the fluorescence intensity is greater because of the development of split phase of glass. In FIG. 6, it shows the relationship between the time of heat treatment and fluorescence radiation spectrum of europium-doped sodium borosilicate glass (59SiO₂-33B₂O₃-8Na₂O-xEu₂O₃), in which, to compare with the fluorescence radiation peak of ⁵D₀→⁷F₂, the fluorescence intensity of the (e) spectrum peak, which is heated for 210 minutes, is nine times greater than that of the (a) spectrum peak without heat treatment. For the same principle, FIG. 7 shows the relationship between the time of heat treatment and fluorescence radiation spectrum of sodium phosphorus silicate glass doped with europium (40SiO₂-35P₂O₅-15Na₂O-6Al₂O₃-1Eu₂O₃). As same as above, to compare with the fluorescence radiation peak of ⁵D₀→⁷F₂, the fluorescence intensity of the spectrum peak, which is heated for 60 hour, is 8.8 times greater than that of the (a) spectrum peak without heat treatment. FIG. 8 shows the europium distribution in the glass before and after split phase to describe the difference of europium ions before and after split phase.

The present invention provides the borosilicate glass doped with rare earth element and phosphorus silicate glass being processed by split phase to form a glass with a nanometer split phase structure. The nanometer split phase structure is described hereunder:

For borosilicate glass, the split phase is phosphate-rich phase and silica-rich phase. As described above, the phosphate glass has a looser structure than the silicate glass, so that, in split phase, the rare earth elements therein will have priority of entering the phosphate-rich phase. In other words, the rare earth element has a greater solubility in the phosphate-rich phase. The phosphate-rich phase likes a sponge with a three-dimension web-like structure in the silica-rich phase (FIG. 9) or water drop like with independent particles in the silica-rich phase (FIG. 10).

For phosphorus silicate glass, the split phase is phosphate-rich phase and silica-rich phase. As described above, the phosphate glass has a looser structure than the silicate glass, so that, in split phase, the rare earth elements therein will have priority of entering the phosphate-rich phase. In other words, the rare earth element has a greater solubility in the phosphate-rich phase. The phosphate-rich phase likes a sponge with a three-dimension web-like structure in the silica-rich phase (FIG. 9) or water drop like with independent particles in the silica-rich phase (FIG. 10).

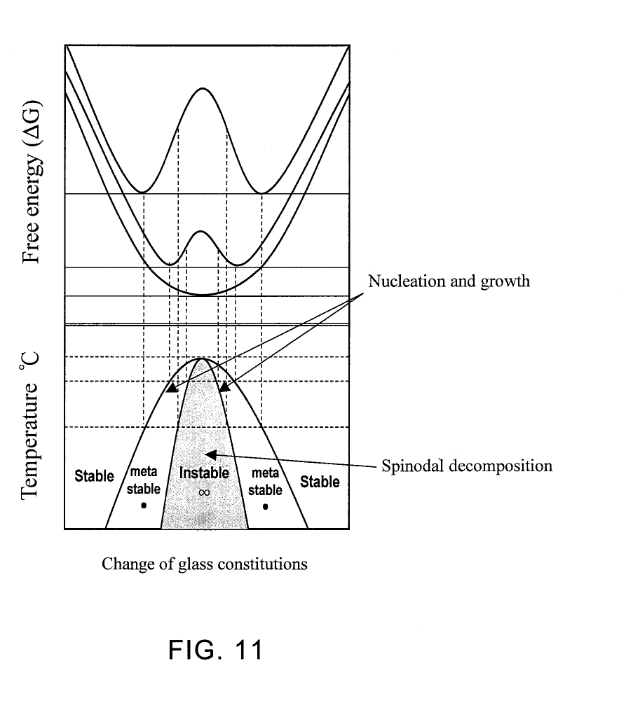

Typically, the split phase of glass is classified into spinodal decomposition and nucleation and growth. As shown in FIG. 11, it shows the constitutions and change of free energy of the binary system when temperature changes in the upper portion and system temperature vs. constitutions (T-x) in the lower portion.

As shown in FIG. 11, the phase separation of spinodal decomposition is occurred at a portion which the free energy curve is curved downward and the constitutions have a very fine variation so that the new phase doesn't need to cross the activated energy barrier and the constitutions of each separation phase is changing until it reach a balance condition. Most of all spinodal decomposition phase separation have a sponge structure of three-dimensional interconnective structure (FIG. 9).

No matter the phosphate-rich phase or the silica-rich phase is formed into a continuous sponge-like crossing distribution through spinodal decomposition or into an independent water-drop-like distribution through nucleation and growth, the effects of fluorescence enhancement are very similar. As long as the split phase of the glasses are in nanometer scale and still have their transparency, they will have the same effect.

The common rare earth element doped glass without split phase treatment can not enhance its fluorescence that should choose the right glass with specific constitutions and heat treatment to form nanometer scale split phases. Furthermore, it also guides most of the rare earth elements entering a phase with loose structure (phosphate-rich phase and silica-rich phase) in the glass split phase process. The glass will have stronger fluorescence as long as all of the three facts above are satisfied, and the technique of the present invention should satisfy these facts.

In conclusion, the present invention provides a method for increasing fluorescence intensity of oxide glass, which provides a nanometer structure made by the glass with nanometer scale split phase and rare earth element having different solubility in different glass constitutions systems to enlarge the fluorescence intensity of the rare earth element in the glass. This technique may be incorporated in any device with rare earth element doped glass to be the light emitting material, such as laser glass, fiber laser, flat display, and optical sensor and the like.

The description above is a few preferred embodiments of the present invention the equivalence of the present invention is still in the scope of the claim of the present invention.

TABLE 1
Chemical constitutions of glass samples

| | |
|---|---|
| europium-doped | europium-doped sodium |
| sodium borosilicate | phosphorus silicate |
| glass (NBS) | glass (NPS) |

| Oxides | mol % | Oxides | mol % |
|---|---|---|---|
| SiO₂ | 40–68 | SiO₂ | 40–68 |
| B₂O₃ | 5–32 | P₂O₅ | 10–42 |
| Al₂O₃ | 0–8 | Al₂O₃ | 0–12 |
| Na₂O | 0–22 | Na₂O | 0–22 |
| Eu₂O₃ | 0.1–3 | Eu₂O₃ | 0.1–3 |

TABLE 2
Acid solution ICP analysis of acid washed split
phase samples

| Constitutions of boron-rich phase | | | | |
|---|---|---|---|---|
| (mole %) | SiO₂ | B₂O₃ | Na₂O | Eu₂O₃ |
| boron-rich | 20.35 | 60.28 | 14.9 | 4.36 |
| phase of split phase glass sample of | | | | |
| 59SiO₂—33B₂O₃—8Na₂O—2Eu₂O₃ | | | | |

TABLE 3
Laser glasses doped with single rare earth
element and laser wavelength

| | | Laser | temper- | |
|---|---|---|---|---|
| Doped | Transfer energy | wavelength | ature | |
| ions | level | (m) | (K) | Glass host |
| Eu³⁺ | ⁵D₀ [symbol] ⁷F₂ | 615 | 300 | Borosilicate |
| Nd³⁺ | ⁴F_{3/2} [symbol] ⁴F_{9/2} | 0.921 | 77 | Silicate, borate |
| | ⁴F_{3/2} [symbol] ⁴I_{11/2} | 1.047–1.08 | 300 | Silicate, borate, |
| | | | | germinate, phosphate, |
| | | | | fluorophosphate |
| | | | | fluoride, tellurite, |
| | | | | chloride |
| | ⁴F_{3/2} [symbol] ⁴I_{13/2} | 1.32–1.37 | 300 | Borate, silicate, |
| | | | | phosphate, fluoride |
| Ho³⁺ | ⁵I₇ [symbol] ⁵I₈ | 1.95–2.08 | 77,300 | Silicate, fluoride |
| Er³⁺ | ⁴I_{13/2} [symbol] ⁴I_{15/2} | 1.53–1.55 | 77,400 | Silicate, phosphate, |
| | | 2.7 | 300 | Fluoride |
| Tm³⁺ | ³H₄ [symbol] ³H₆ | 1.85–2.02 | 77 | Silicate fluoride |
| Yb³⁺ | ²F_{5/2} [symbol] ²F_{3/2} | 1.01–1.06 | 77 | Borate, silicate |
| Gd³⁺ | ⁷P_{7/2} [symbol] ⁸S_{7/2} | 0.312 | 77 | Silicate |

What is claimed is:

1. A method of increasing a fluorescence intensity of an oxide glass, comprising performing a glass split phase technique to make the oxide glass with a strong structure phase, which has a three-dimensional continuous web-like distribution, and a weak structure phase, which has a continuous web-like distribution or an independent drop-like distribution to receive rare earth elements more than the strong structure phase, therefore, the rare earth elements are concentrated in the weak structure phase to increase the fluorescence intensity of the oxide glass by an increase of a concentration and a fluorescence efficiency of the rare earth elements.

2. The method as defined in claim 1, further comprising the steps of:
a) preparing a oxide glass material with rare earth elements;
b) melting the oxide glass material to form the oxide glass; and
c) performing a heat treatment on the oxide glass to make it occur split phase and form the strong structure phase and the weak structure phase of nanometer scale that the rare earth elements may enter the weak structure phase to for a nano-gathering effect.

3. The method as defined in claim 2, wherein the oxide glass material is a silicate glass material.

4. The method as defined in claim 3, wherein the silicate glass material is a borosilicate glass or a phosphorus silicate glass.

5. The method as defined in claim 4, wherein the oxide glass material further includes alkali oxides or other glass modifiers.

6. The method as defined in claim 4, wherein the borosilicate glass includes 40%˜68% silicon oxide (SiO₂), 5%˜32% boric acid (H₃BO₃), 0˜8% aluminum oxide (Al₂O₃), 0˜22% sodium oxide (Na₂O), and 0.1%˜3% europium oxide (Eu₂O₃).

7. The method as defined in claim 6, wherein the phosphorus silicate glass includes 40%˜68% silicon oxide (SiO₂), 10%˜42% phosphoric acid (P₂O₃), 012% aluminum oxide (Al₂O₃), 0˜22% sodium oxide (Na₂O), and 0.1%˜3% europium oxide (EU₂O₃).

8. The method as defined in claim 1, wherein the glass split phase technique includes cutting the oxide glass into a predetermined size and performing a predetermined heat treatment on the oxide glass, and then cooling the oxide glass to a room temperature.

9. The method as defined in claim 8, wherein the oxide glass is heated to 500° C. to 820° C. in the heat treatment.
